(19) United States
(12) Patent Application Publication
(10) Pub. No.: US 2021/0091374 A1
(43) Pub. Date: Mar. 25, 2021

(54) NAPLES AND Pb-Sb-Sn YELLOWS - COMPOSITION AND METHODS OF USE

(71) Applicants: Addenda LLC, INDIANAPOLIS, IN (US); GUANGZHO ADDENDA CHEMICAL CORPORATION, LTD, Guangzhou (CN)

(72) Inventors: Gary R. Mitchener, ZIONSVILLE, IN (US); LI ZHI BIN, Guangzhou (CN); SARAH A. ROTHSTEIN, INDIANAPOLIS, IN (US)

(73) Assignees: Addenda LLC,, INDIANAPOLIS, IN (US); GUANGZHO ADDENDA CHEMICAL CORPORATION, LTD, Guangzhou (CN)

(21) Appl. No.: 16/578,313

(22) Filed: Sep. 21, 2019

(51) Int. Cl. H01M 4/20

(52) U.S. Cl. CPC H01M 4/20; H01M 10/12

(57) ABSTRACT

A method of manufacturing a lead-acid battery, including the steps of making paste from leady oxide, sulfuric acid, lead powder, Naples Yellow, and water, pasting a lead-containing alloy grid to define an uncured battery plate, curing the pasted battery plate, positioning the cured plate in a lead-acid battery cell, and charging the cell convert the basic lead sulfate crystal structures into lead dioxide containing one or more of the ancient pigments.

### TECHNICAL FIELD

The novel technology relates generally to electrochemistry, and more particularly, to a battery incorporating ancient artist's pigments as functional battery plate paste additives.

### BACKGROUND

Lead-acid batteries have been in use for quite some time—decades in fact. The methods of production for lead acid batteries are well known. The methods generally involve paste mixing, plate pasting, plate curing and drying using equipment common in the industry. Lead acid batteries have the distinction of being the first practical rechargeable battery design, and are still in wide use for providing power to start vehicles and provide energy storage. Lead-acid batteries include a pair of electrodes and a plurality of charged or chargeable plates immersed in an aqueous sulfuric acid electrolyte. During the first century of lead acid battery production, a lead-antimony alloy was typically used to manufacture grids. With the introduction of lead-calcium alloys for the plate grids, however, the life of the battery on deep discharge cycling declined dramatically. This was sometimes referred to as the “antimony free-effect.” Also, later in the 20^{th} century, when maintenance-free VRLA batteries were in introduced with lead-calcium alloy grids, battery performance suffered.

Separately, during the 20^{th} century, it became known that by curing the pasted plates in an oven at temperatures exceeding 65 to 70 C, the final basic lead sulfate crystal phase would be predominately “tetrabasic” rather than “tribasic” which generally led to longer battery life. Additionally, it was later discovered that by adding small amounts (1% to 2%) tetrabasic lead sulfate “seed” material to the paste mix, multiple benefits resulted. Most significantly, total oven curing times could be reduced, curing temperatures could be reduced, the tetrabasic lead sulfate crystals formed were of a more uniform size, and sizing could be somewhat controlled by the quantity of “seeds” added.

To overcome the decline in battery performance accompanying the switch to lead-calcium grid alloys, some battery producers found they could add back into the paste mix a source of antimony, like common antimony trioxide, and, recover some of the lost performance. Unfortunately, it was discovered later, when ovens came into use for curing to result in the formation of the tetrabasic lead sulfate crystal phase, that the cured plates were predominately tribasic lead sulfate. The cause was that the antimony trioxide reacted to form antimony sulfate which increased the solubility of antimony in the electrolyte which acted as a crystal modifier and interfered with the formation of the tetrabasic lead sulfate phase.

These plates degrade over time and with repeated charge/discharge cycles There remains a need for a lead-acid battery having longer life by containing both a source of antimony and/or tin and tetrabasic lead sulfate in a cured plate. The present novel technology addresses this need.

### DESCRIPTION OF PREFERRED EMBODIMENTS

For the purposes of promoting an understanding of the principles of the novel technology, reference will now be made to the embodiments illustrated in the drawings, if any, and specific language will be used to describe the same. It will nevertheless be understood that no limitation of the scope of the novel technology is thereby intended, such alterations and further modifications n the illustrated device, and such further applications of the principles of than novel technology as illustrated therein being contemplated as would normally occur to one skilled in he art to which the novel technology relates.

A typical lead acid battery includes a positive and negative terminal, and a plurality of positively and negatively charged “plates” that are arrayed between, the terminals within a housing of a battery to define a plurality of cells. Dielectric spacers are positioned between the plates of adjacent cell to prevent electrical shorting In a lead-acid battery, the plates are immersed in an aqueous sulfuric acid bath known as the electrolyte.

In order to make the plates, screen or grid-like members are first formed from metal, typically lead or a lead containing alloy. A paste is typically formed by a mixture of leady oxide, sulfuric acid, water, and other minor additives. The other minor additives are typically, but not limited to, flock or other glass or synthetic fibers. oxides and/or hydroxides of tin, titanium, antimony and bismuth. The materials are placed in a mixer and mixed to yield a viscous paste precursor by the use of methods and equipment common in the industry. During paste mixing, chemical reactions begin that create different basic lead sulfite crystal phases. These chemical reactions continue during the later pasting, curing, and drying steps of production. It is also well known that by controlling process conditions such as temperature, humidity, and time as well as the addition of certain additives, the final mix of crystal phases can be altered or directed. After the paste is thoroughly mixed in a mixer, the paste precursor is then applied to the metal grids. After the paste is applied t the grids, the paste is then cured by placing the skid of uncured (green) plates into an oven, where humidity (steam) and to some extent heat could be controlled. Typical paste/phase compositions that could be present in the final cured and dried positive plate could be unreacted lead oxide, various lead sulfate phases and free lead metal.

During the curing process, chemical reactions take place between the ingredients of the paste mix. The free lead metal and lead oxides react with the sulfuric acid, gradually cony ting the lead paste into a crystal array of lead sulfates. Generally, three phases or morphologies of lead sulfate crystals may be formed during the curing process. The first type is larger, high aspect ratio, prismatic tetrabasic lead sulfate particles. The second are smaller, generally needle-like or acicular tribasic lead sulfate particles. The third type are monobasic lead sulfate particles. Of the three types, tetrabasic and tribasic are the predominantly formed particles.

For certain types of batteries, it was found in time that the larger tetrabasic particles give rise to better long-term properties when used in industrial batteries and the smaller, needle-like tribasic crystals were more suited for automotive type. For that reason, techniques were designed to maximize the relative amount of larger tetrabasic particles, while minimizing the yield of smaller, acicular, needle-like tribasic particles. This was initially achieved through humidity and temperature controls in the oven during the curing process.

Over the years, the technology of battery manufacture has evolved to increase the yield of tetrabasic particles and also increase the efficiency of the operation. One such method for increasing the efficiency of the process and for increasing the percentage of tetrabasic particles was to add tetrabasic “seed” crystals to the paste. The addition of tetrabasic seed crystals helps to promote the formation of, predominately, if not all, tetrabasic crystals in the cured paste, fairly uniform in size, rather than other lead sulfate phases.

Other additives, such as stannous sulfate, actually inhibit the conversion to the tetrabasic lead sulfate crystal phase and result in tribasic lead sulfate being the predominate phase in the final cured plate.

It is also well known that the presence of the element antimony, at some minor level, is important for good battery performance. In certain batteries, the source of the antimony typically came from the lead-antimony alloy used in the metal grid material. During the cycling (charging and discharging) of the battery, electrochemical reactions resulted in enough antimony migrating out of the grid and into the active material of the plate to have a positive effect on battery performance and life. In some cases, when the lead-antimony alloy for the grid was changed to a lead-calcium alloy, the life of the battery decreased dramatically.

As a result, efforts were made to add back into the paste mix an antimony chemical. Antimony trioxide was tried as an additive, but it was discovered that its presence in the paste mix interfered with the formation of the tetrabasic lead sulfate crystal phase. This underscored the need for the discovery of an antimony and/or tin chemical that did not interfere with creating the beneficial tetrabasic lead sulfate phase in the cured plate.

The final step in the battery manufacturing process as the formation step. The formation step comprised the part where the grids were appropriately charged to contain the elect potential desired within the battery.

In order to overcome this problem, Applicant has invented the current paste precursor composition. This novel composition includes the addition of ancient yellow pigments used by artists for centuries. One such pigment is commonly referred to as Naples Yellow. It is a lead-antimony-oxygen mixture sometimes referred to as lead antimonate which is a somewhat loose term to describe several documented and known phases hat resulted from the high temperature reaction between the oxides of lead and antimony. The resulting phases such as, but no limited to, Pb₂Sb₃O₇, PbSb₂O₆, Pb₃Sb₂O₆, and/or mixtures thereof, typically calcined at temperatures generally greater than 500 C. Lead antimonate yellow pigments have been used since the middle ages to color ceramics, glazes and when ground to a fine powder was used as a pigment by artists in creating paintings.

Other ancient pigments were also found suitable for use in the lead acid battery. They include lead-tin yellow, which includes phases identified as lead-tin yellow Type 1 (Pb₂SnO₄), lead-tin yellow type 2 (PbSnO₃) lead stannate (Pb₂Sn₂O₆), lead-antimony-tin oxide (Pb₂SbSnO_{6.5}), combinations or mixed phases thereof, and the like.

The paste is created using different amounts of leady oxide, red lead powder, Naples Yellow, lead-tin yellow, sulfuric acid, and water. The amounts needed for the paste can vary. Typically, the paste will comprise of 77 to 85 weight percent leady oxide. However, these ranges can also include 70 to 90 weight percent, 65 to 95 weight percent and 79 to 83 weight percent of leady oxide. The typical amount of red lead powder includes 0 to 15 weight percent, but could also include 0 to 20 weight percent, 3 to 12 weight percent, and 5 to 10 weight percent. For Naples Yellow, the typical amount includes 0.1 to 5 weight percent, but could also include 0.05 to 10 weight percent, 0.5 to 3 percent, and 1 to 2 weight percent. Typical amounts of lead-tin yellow include 0.1 to 5 weight percent, but could also include 0.05 to 10 weight percent, 0.5 to 3 weight percent, and 1 to 2 weight percent. The typical amount of 50% wt/wt sulfuric acid includes 4 to 10 weight percent, but also include 1 to 15 weight percent, 5 to 9 weight percent and 6 to 7 weight percent. Alternately, the sulfuric acid may be added at different concentrations, such as 10% wt/wt, 30% wt/wt, 70% wt/wt, 90% wt/wt, or the like. The amount of water present in the composition can range between 11 to 13 weight percent, 9 to 15 weight percent, and 10 to 13 weight percent.

One thing these ancient pigments of lead and/or antimony and/or tin oxides had in common was that they were manufactured at high temperatures and the resulting pigments were glassy ceramics that, similar to lead/tin/antimony alloys, were not very soluble in the sulfuric acid electrolyte of the lead acid battery. This inhibited the antimony and/or tin from becoming solubilized and interfering with the formation of the tetrabasic lead sulfate crystal phase.

The addition of these ancient pigments to the paste mixture offers the advantage of adding a desired antimony and/or tin element to enjoy the advantages of increased battery life without sacrificing the advantages gained by the preferential growth of tetrabasic lead sulfate crystals and/or suffering the effects of excess tribasic lead sulfate crystals In other words, by adding antimony and/or tin to the paste composition in the form of these ancient pigments, the benefits of antimony and/or tin can be realized along with the benefits of controlled morphology of the lead sulfate crystals favoring tetrabasic morphology crystals grown, with or without the presence of “seed” material.

### EXAMPLE 1

A paste may be made from leady oxide, sulfuric acid, red lead powder, Naples Yellow, and water. Specifically, to a powder precursor of 200 grams leady oxide, 8 grams red lead powder, and 2 grams Naples Yellow may be added 22.5 grams of water and then 18 grams of 50% sulfuric acid, and the resulting mixture may be mixed to define a mixture. The mixture may be thoroughly stirred to yield a homogeneous paste.

The mixture may theft be pasted into the metallic (typically lead or lead alloy) grid. The pasted grid plate may then be cured, typically in an environment of high relative humidity (typically >90% percent) and at an elevated curing temperature (typically above 70° C.) for about 24 hours and then reducing the humidity over 6 to 8 hours and maintaining a temperature of 75° C. until the final humidity target of <5% is reached.

A control sample pasted grid plate was made in a similar manner except the Naples Yellow additive was replaced with the same weight of antimony trioxide. The results of the X-ray diffraction (XRD) analysis showed the novel use of Naples Yellow in the paste mix resulted in conversion of the cured plate to the tetrabasic lead sulfate crystal phase while the control plate with antimony trioxide inhibited conversion to tetrabasic lead sulfate and resulted in a cured plate containing predominately the tribasic lead sulfate phase.

Post curing, the cured plates may be positioned in a lead-acid battery housing to define cells, with respective plates separated by dielectric layers. The cells may be initially charged via application of an electric potential (formation step), whereby the (mostly tetrabasic) lead sulfate crystals are converted to lead dioxide containing lead-antimony oxide.

While the novel technology has been illustrated and described in detail in the drawings (if any) and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specifications. Accordingly, it is understood that all changes and modifications that come within the spirit of the novel technology are desired to be protected.

We claim:

1. A method of manufacturing a lead-acid battery, comprising in combination:
a) making a paste from leady oxide, sulfuric acid, water, and one of the group comprising Naples Yellow, lead tin yellow, and combinations thereof;
b) pasting a lead-containing metallic grid to define an uncured battery plate;
c) curing the uncured battery plate to yield a cured battery plate;
d) positioning the cured battery plate in a lead-add battery cell; and
e) charging the cell to yield a formed plate.

2. The method of claim 1 wherein step c) is carried out in an environment of high relative humidity and at an elevated temperature.

3. The method of claim 1 wherein during step c), lead and leady oxides react with sulfuric acid in the presence of Naples Yellow to form lead sulfate crystals having tetrabasic lead sulfate morphology.

4. The method of claim 1 wherein step a) is making a paste from leady oxide, sulfuric acid, water, lead powder, and one of the group comprising Naples Yellow, lead tin yellow, and combinations thereof.

5. The method of claim 1 wherein during e), the lead sulfate crystal structure converted to lead dioxide containing Naples Yellow.

6. The method of claim 1 wherein Naples Yellow is selected from the group comprising Pb₂Sb₂O₇, PbSb₂O₆, and mixtures thereof; and
wherein lead-tin yellow is selected from the group comprising Pb₂SnO₄, PbSnO₃, Pb2Sn₂O₆, PbSbSnO_{6.5}, and combinations thereof.

7. The method of claim 4 wherein the paste is made from 200 grams leady oxide, 8 grams red lead powder, 2 grams selected from the group, comprising Pb₂Sb₂O₇, PbSb₂O₆, Pb₃Sb₂O₆ and mixtures thereof, 18 grams 50% molar sulfuric acid, and 22.5 grams water; and wherein curing occurs in an atmosphere having greater than 90% relative humidity and at a temperature between 70 degrees Celsius and 95 degrees Celsius for 24 hours.

8. A paste composition for making battery plates, comprising:
65 to 95 weight percent leady oxide;
0 to 20 weight percent red lead powder;
0.05 to 10 weight percent Naples Yellow;
0 to 10 weight percent lead-tin yellow;
1 to 15 weight percent sulfuric is acid; and
9 to 15 weight percent water.

9. The paste composition of claim 8 wherein the paste composition comprises:
77 to 85 weight percent leady oxide;
1 to 15 weight percent red lead powder;
0.1 to 5 weight percent Naples Yellow;
0.1 to 5 weight percent lead-tin yellow;
4 to 10 weight percent sulfuric acid; and
11 to 13 weight percent water.

10. The paste composition of claim 8 wherein Naples Yellow is selected from the group comprising Pb₂Sb₂O₇, PbSb₂O₆, Pb₂Sb₂O₆, and combinations thereof.

11. The past composition of claim 10 wherein lead-tin yellow is selected from the group comprising Pb₂SnO₄, PbSnO₃, PbSn₂O₆, Pb₂SbSnO6.5, and combinations thereof.

12. The paste composition of claim 8 wherein all of the components are homogeneously mixed.

13. The paste composition of claim 8 wherein lead-tin yellow is present in amounts from 0.1 to 10 weight percent.

14. A homogeneous paste for making lead-acid battery plates, consisting of:
water;
leady oxide powder;
one of the group comprising Naples Yellow powder, lead-tin yellow, and mixtures thereof; and
sulfuric acid.

15. The homogeneous paste of claim 14 and further comprising lead powder.

16. The homogeneous paste of claim 14 wherein the homogeneous paste includes both Naples Yellow and lead-tin yellow.

17. The homogeneous paste of claim 14 wherein Naples Yellow is selected from the group comprising Pb₂Sb₂O₇, PbSb₂O₆, Pb₃Sb₂O₆, and mixtures thereof; and wherein lead-tin yellow is selected from the group comprising Pb₂SnO₄, PbSnO₃, Pb₂Sn₂O₆, Pb₂SbSnO_{6.5}, and combinations thereof.
